(19) United States
(12) Patent Application Publication
(10) Pub. No.: US 2021/0187845 A1
(43) Pub. Date: Jun. 24, 2021

(54) VARIABLE HEIGHT RECOATER BLADE

(71) Applicant: Hamilton Sundstrand Corporation, Charlotte, NC (US)

(72) Inventor: Paul M. Colson, Westfield, MA (US)

(21) Appl. No.: 16/723,281

(22) Filed: Dec. 20, 2019

(51) Int. Cl. B29C 64/214; B29C 64/153; B29C 64/393; B33Y 10/00; B33Y 30/00; B33Y 50/02; B22F 3/105

(52) U.S. Cl. CPC B29C 64/214; B29C 64/153; B29C 64/393; B22F 2003/1057; B33Y 30/00; B33Y 50/02; B22F 3/1055; B33Y 10/00

(57) ABSTRACT

A method of controlling powder in an additive manufacturing process includes solidifying a portion of a first layer of powder to form a first layer of a workpiece. A first topology indicative of the first layer of powder and the first layer of the workpiece is captured. The recoater is moved across the second layer of powder. Heights of portions of the recoater are varied while moving the recoater, based on the first topology captured, to avoid contact of the recoater with solidified portions of the first layer that could stress the portions of the recoater if the heights of the portions were not varied.

### BACKGROUND

The present disclosure relates to additive manufacturing. More particularly, the present disclosure relates to methods and systems for monitoring an additive manufacturing build process.

Powder bed fusion additive manufacturing processes offer a technique capable of manufacturing a myriad of aerospace components and assemblies. Additive manufacturing processes operate application of multiple successive broad powder layers and then subsequent fusion of specific areas of powder to form a three dimensional workpiece. With additive powder bed fusion processes, certain build parameters and geometries can cause resulting thicknesses of solidified material to be greater than corresponding thicknesses of next powder layers, thus making contact with and potentially damaging a recoater blade as a new layer of powder is applied. This can cause interruptions in the build process as the recoater blade is repaired or replaced, often necessitating that the partially-built workpiece be scrapped.

### SUMMARY

A method of controlling powder in an additive manufacturing process includes solidifying a portion of a first layer of powder to form a first layer of a workpiece. A first topology indicative of the first layer of powder and the first layer of the workpiece is captured. The recoater is moved across the second layer of powder. Heights of portions of the recoater are varied while moving the recoater, based on the first topology captured, to avoid contact of the recoater with solidified portions of the first layer that could stress the portions of the recoater if the heights of the portions were not varied.

An additive manufacturing system includes a powder bed with a build plate, a recoater, a plurality of pins supported by the recoater, and a sensor. The recoater positioned above the powder bed and disposed to wipe across a top of the powder bed. The plurality of pins are configured to be individually moved relative to the recoater while the recoater is being wiped across the top of the powder bed. The sensor is configured to capture a topology of the powder bed for use in moving the plurality of pins relative to the recoater.

A method of controlling a height of deposited powder includes depositing a first layer of powder onto a powder bed. A portion of the first layer of powder is solidified to form a first layer of a workpiece. A first topology dataset is captured. Any areas of discontinuity are identified. A first output dataset based is created on the identified areas of discontinuity. The first output dataset is converted to a first set of instructions for a recoater of the additive manufacturing system. A second layer of powder is deposited on the first layer of the workpiece and on top of the first layer of powder. The recoater is slid across the second layer of powder. The heights of individual pins of the pin array are varied based on the first set of instructions from the controller as the recoater is slid across the second layer of powder.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a side view of a powder bed additive manufacturing system.

FIG. 2 is a perspective view of a backside of the recoater blade and shows a pin array.

FIG. 3A is a perspective view of a pin and a first leading edge element.

FIG. 3B is a perspective view of the pin array and a second leading edge element.

FIG. 4 is a flowchart of a method of using the recoater to adjust a thickness of a powder layer.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The proposed system utilizes a recoater blade including an array of tightly spaced individually height adjustable square pins. The heights of these pins can be adjusted based upon measurements of variations in layer thickness from a height measurement and visual identification system. As layers of the solid workpiece are built up, the pins are controlled to be adjusted (each with an individual actuator) up or down based on the data from the measurement system so as to avoid areas of the formed workpiece with elevated solids coming into contact with the adjustable pins.

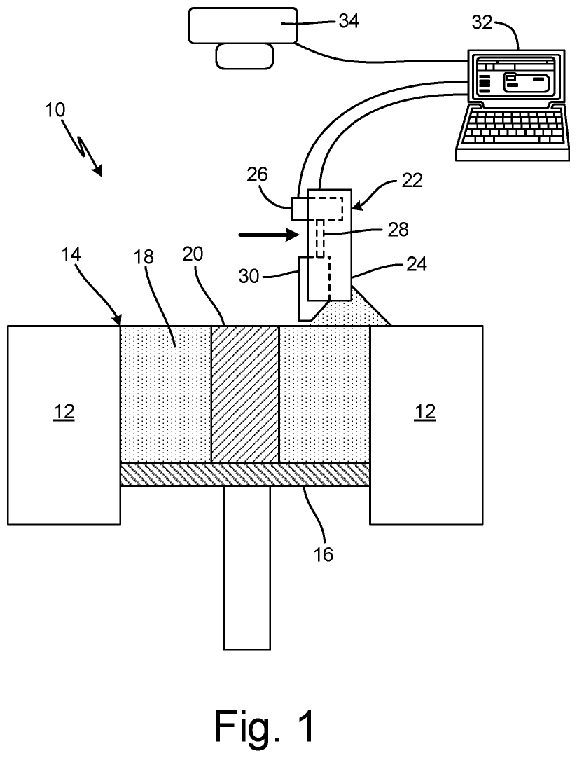

FIG. 1 is a side cross-section view of additive manufacturing system 10 and shows container walls 12, powder bed 14, build plate 16, powdered material 18, workpiece 20, recoater 22 (with shield 24, actuator 26, driving arm 28, and pin array 30), controller 32, and sensor 34.

Additive manufacturing system 10 is a machine configured to produce objects with layer-by-layer additive manufacturing. In some non-limiting embodiments, additive manufacturing system 10 can be configured for laser additive manufacturing, laser powder bed fusion, electron beam powder bed fusion, laser powder deposition, electron beam wire, and/or selective laser sintering to create a three-dimensional object out of powdered material 18. Container walls 12 are containment walls that help to contain the four sides of powder bed 14. Powder bed 14 includes build plate 16, powdered material 18, and workpiece 20. Build plate 16 is a platform that is configured to move in a vertical direction (up and down as shown in FIG. 1.). Powdered material 18 is feedstock material in powdered form. In some non-limiting embodiments, powdered material 18 can be or include titanium alloys, nickel alloys, aluminum alloys, steel alloys, cobalt-chrome alloys, copper alloys, or other types of powdered metal alloys. In some embodiments, powdered material can include polymer powder. Workpiece 20 is an article being constructed by the layer-by-layer additive manufacturing process of additive manufacturing system 10.

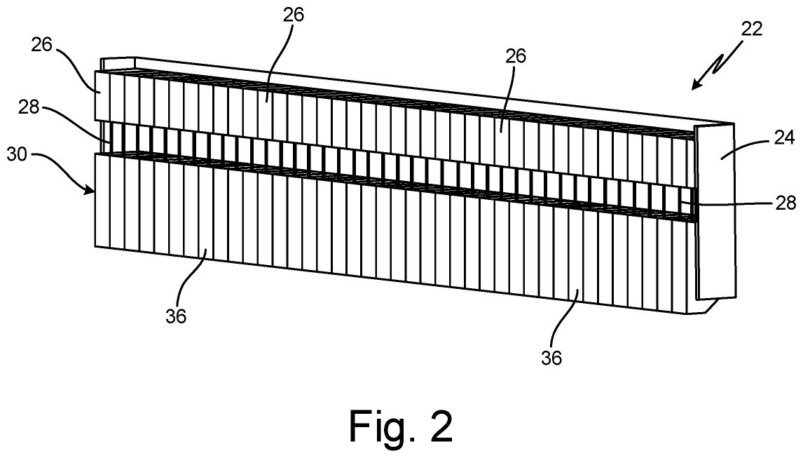

Recoater 22 is a powder wiping device. Shield 24 is a panel or wall. Actuator 26 is a device for causing movement. In this example, actuator 26 includes a plurality of individual actuators 26 (see e.g., FIG. 2). Also in this example, actuator 26 can include a circular or linear actuator. A type of actuator 26 can include an electric, hydraulic, or pneumatic actuator. Driving arm 28 is an elongate piece of solid material such as a rod or shaft. Pin array 30 is a plurality of individual pins (see e.g., FIG. 2). In this example, a shape of each pin of pin array 30 is polyhedral and generally in the shape of a rectangular box. Controller 32 is an electronic control device. In this non-limiting embodiment, controller 32 is a computer. Sensor 34 is an instrument for sensing a surface profile or topography. As referred to hereinafter sensor 34 can be a structured light or a laser scanner, but a person skilled in the art will recognize that other forms of topographic sensors can alternatively be used.

Container walls 12 are disposed on the sides of and are in contact with powdered material 18 of powder bed 14. Powder bed 14 is positioned below sensor 34. Build plate 16 is positioned between container walls 12 and is in contact with the bottom sides of powdered material 18 and workpiece 20. Powdered material 18 is disposed on build plate 16 and between container walls 12. Workpiece 20 is disposed in and surrounded by a portion of powdered material 18 and sits upon build plate 16. Recoater 22 is positioned above build plate 16 and is configured to move relative to powdered material 18. In this example, recoater 22 is electrically connected to controller 32 via wires.

Shield 24 is mounted to a front of recoater 22 (with the front of recoater 22 being on the right side of recoater 22 as shown in FIG. 1). Actuator 26 is attached and mounted to a backside of shield 24. Driving arm 28 extends between and is connected to actuator 26 and to pin array 30. Pin array 30 is mounted on and slideably engaged with shield 24. Controller 32 is positioned away from powder bed 14 and is in data communication with recoater 22 and sensor 34. In this example, sensor 34 is mounted above powder bed 14. In this example, sensor 34 is electrically connected to controller 32 via wires.

Container walls 12 contain powdered material 18 within powder bed 14. Powder bed 14 is used to form workpiece 20 from powdered material 18 by way of selectively solidifying portions of powdered material 18. Build plate 16 functions as a base upon which powdered material 18 is placed and that supports workpiece 20. As workpiece 20 is formed, build plate 16 lowers after each layer of workpiece 20 is iteratively formed. Powdered material 18 serves as feedstock or raw material from which workpiece 20 is solidified and formed. After a layer powder spreading step, recoater 22 is drawn across a top surface of powder bed 14 to wipe or scrape a portion of powdered material 18 from powder bed 14. In this example, recoater 22 moves from left to right (as shown in FIG. 1).

During use of recoater 22, shield 24 acts as a support to which actuator 26 and pin array 30 are mounted. As recoater 22 is drawn across powder bed 14, shield 24 pulls actuator 26, driving arm 28, and pin array 30 across powder bed 14. Actuator 26 drives up and down motion of driving arm 28. As driving arm 28 is driven up and down by actuator 26, driving arm 28 pushes pin array 30 up and down relative to shield 34. Pin array 30 moves up and down relative to shield 24 as recoater 22 is drawn across powder bed 14.

Controller 32 controls and receives communications from the various components of additive manufacturing system 10. In this example, controller 32 also stores a machine learning algorithm that is used, in conjunction with the data from sensor 34, to actively monitor the additive manufacturing build-process layer by layer. The machine learning algorithm is configured to continually monitor the topographical data from sensor 34 and adjust the heights of each pin of pin array 30 based on height measurements powdered material 18 and workpiece 20. In this example, sensor 34 emits a signal that is reflected off of powdered material 18 and workpiece 20. The reflected beam is then captured by a detector on sensor 34. Based on an angle and time of return of the beam and a location on sensor 34, sensor software can determine how far the surface of powder bed 14 is away from sensor 34. In this way, sensor 34 can capture a three-dimensional map (e.g., topographical profile) of various surface heights of powder bed 14 after a layer of workpiece 20 has been incrementally solidified and/or as powder bed 14 is recoated with powder.

Additive manufacturing system 10 utilizes sensor 34 to scan powder bed 14 as powder bed 14 is being formed by the additive manufacturing layer powder spreading process. Sensor 34 allows for capture of a topography of the surface of powder bed 14. For example, sensor 34 captures an image of powder bed 14 after solidification of a layer of powdered material 18 is complete. After sensor 34 captures a topological profile of powder bed 14, controller 32 measures deviations from a nominal model and determines relative height data. The height data is then used to monitor and adjust positions of each pin in pin array 30 based on the topology of powder bed 14. As layers of powdered material 18 and workpiece 20 are built up, the pins of pin array 30 are controlled to move up or down to avoid areas of powder bed 14 with elevated solids (e.g., portions of workpiece 20) in response to the topographical data of powder bed 14.

FIG. 2 is a perspective view of a backside of recoater 22 and shows shield 24, actuators 26, driving arms 28, and pin array 30 with pins 36. Here, recoater 22 is shown as including pin array 30 with a plurality of pins 36. In alternative embodiments, pin array 30 can include more or fewer pins 36 than shown in FIG. 2. In this example, there are approximately eight pins 36 per inch. In other words, a width of each of pins 36 can be approximately 0.125 inches. Each of pins 36 is individually replaceable as wear occurs. Each of pins 36 is connected to and slideably engaged with both shield 24 and with an adjacent pin 36.

In order to prevent powder flow between adjacent pins, recoater 22 can include one or more of the following features (alone or in combination). In one non-limiting embodiment, individual pins 36 can be ship-lapped to each other. In another non-limiting embodiment, a seal element can be provided between each of pins 36. Additionally, interfaces between each individual pins 36 can be angled. Recoater 22 can also include one or more of the following features (alone or in combination) to limit or prevent non-linear motion of pins 36 relative to shield 24. For example, pins 36 can interface with grooved bearing surfaces in shield 24 to limit forward and backward and/or side-to-side motion. In another example, pins 36 can include tracks (e.g., tongue and groove) to limit forward and backward and/or side-to-side motion. In yet another example, additive manufacturing system 10 can contain a sealing gas pressurizing pin (e.g., a retention connection) above the build chamber to limit contamination of powdered material 18. These and other features can be incorporated to maintain long wear life, minimize required maintenance, and to limit contamination of the manufacturing process.

A vertical position of each individual pin 36 is provided by recoater 22. For example, each individual actuator 26 drives an individual driving arm 28 which drives the vertical motion of an individual pin 36. In this way, pin array 30 with pins 36 enables a resolution across pin array 30 of powder bed topology as pin array 30 is drawn across powder bed 14. For example, the vertical heights of pins 36 can be adjusted so as to create a contour with varying valleys and apexes to control a height (e.g., topology) of powdered material 18 as recoater 22 is drawn across powder bed 14. The desired resolution of the powder bed topology can be based on one or more of the following factors: powder material, length and width of powder bed 14, powder size distribution, component surface finish of workpiece 20, and build rate.

The adjustability of pins 36 of pin array 30 allows recoater 22 to avoid areas of powder bed 14 with elevated solids (e.g., elevated portions of workpiece 20) that could otherwise damage recoater 22.

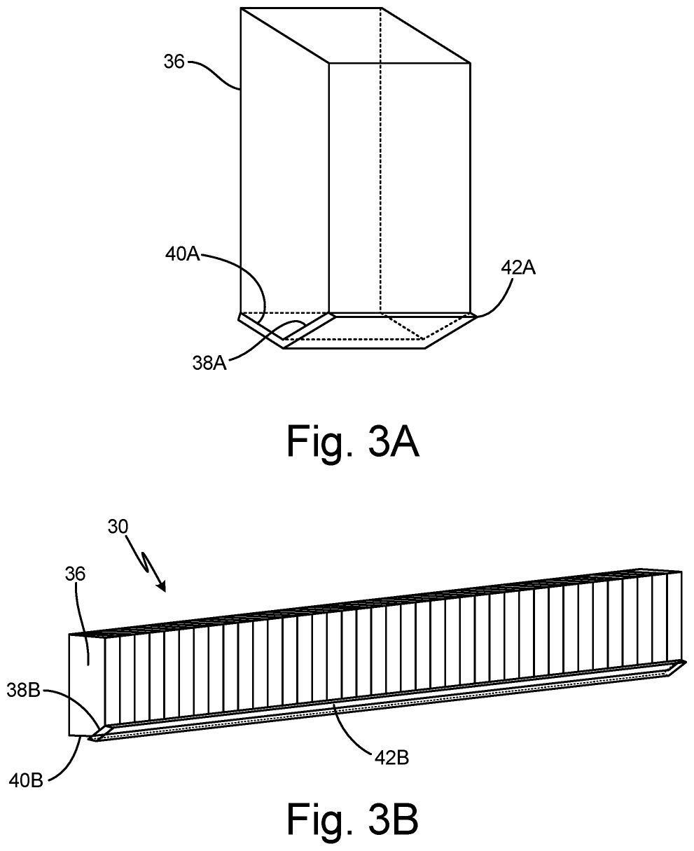

FIG. 3A is a perspective view of an individual pin 36 of pin array 30 and shows leading edge 38A, bottom face 40A, and covering 42A. Leading edge 38A is a face of pin 36 that faces towards shield 24 (see e.g., FIGS. 1-2). Bottom face 40A is a face of pin 36 that is located on an end of pin 36. Covering 42A is a piece of solid material. In this example, a material of covering 42A can be elastomer or metal. Leading edge 38A is positioned so as to be on a leading edge of pin 36 as recoater 22 is drawn across powder bed 14. Bottom face 40A is disposed on a bottom end of pin 36 (with top-bottom orientation shown as up-down in FIG. 3A).

In this example, covering 42A is attached to and extends across both of leading edge 38A and bottom face 40A of pin 36. In other non-limiting embodiments, covering 42A can be attached to and extend across just one of either leading edge 38A or bottom face 40A of pin 36. As shown in FIG. 3A, covering 42A extends a width of pin 36. In such an example, each of pins 36 of pin array 30 can include their own respective, discrete covering 42A mounted to each pin 36 (different from a continuous covering as shown in FIG. 3B).

In one example, covering 42A acts as a squeegee (or squilgee) to wipe powdered material 18. Covering 42A also provides a protective barrier between pin 36 and powdered material 18 and workpiece 20. Covering 42A prevents the wearing down of pin 36 throughout the lifecycle of recoater 22. For example, covering 42A can provide a material hardness that is different from that of the material of pin 36 and such that the hardness of covering 42A improves the durability of recoater 22 as pins 36 are drawn across powdered material 18. Covering 42A also provides a coefficient of friction that is different from that of a material of pin 36 and such that the coefficient of friction of covering 42A improves the behavior (e.g., flowability) of powdered material 18 as pins 36 are drawn across powdered material 18 by recoater 22. In another example, covering 42A can be detachable so as to allow for replacement of covering 42A as covering 42A wears or becomes damaged.

FIG. 3B is a perspective view of pin array 30 and shows pins 36, leading edges 38B, bottom faces 40B, and covering 42B. In contrast to covering 42A shown in FIG. 3A, covering 42B in FIG. 3B is shown as extending across the entire expanse (or width) of pin array 30. Covering 42B is connected and mounted to each individual pin 36 of pin array 30. In this example, covering 42B can be attached to each of pins 36 at a single point of each pin 36 such that a minor rotation of a localized portion of covering 42B is permitted with respect to each pin 36. This minor rotation of covering 42B enables covering 42B to bend and flex in response to the position adjustments of pins 36. The minor localized rotations of covering 42B also enable covering 42B to occupy a continuous curved shape along the width of pin array 30. This flexibility of covering 42B provides improved resolution and smoother topology of powder bed 14 thereby allowing for improved quality (e.g., surface finish, dimensional accuracy, etc.) of workpiece 20.

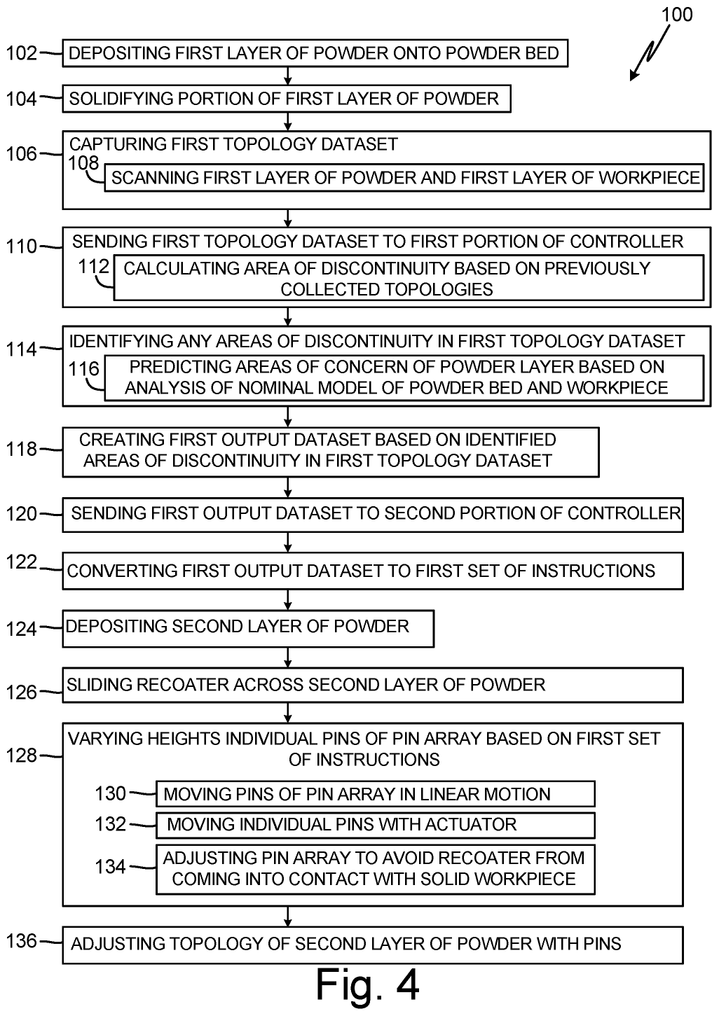

FIG. 4 is a flowchart of method 100 of controlling a height of deposited powder in an additive manufacturing process. Method 100 includes steps 102 through 136.

Step 102 includes depositing a first layer of powder onto powder bed 14 of additive manufacturing system 10. Step 104 includes solidifying a portion of the first layer of powdered material 18 to form a first layer of workpiece 20. Step 106 includes capturing a first topology dataset of the first layer of powdered material 18 and the first layer of workpiece 20. Step 106 also includes step 108 of scanning the first layer of powdered material 18 and the first layer of workpiece 20 with sensor 34 (e.g., a structured light or a laser scanner). Step 110 includes sending the first topology dataset to a first portion of controller 32. Step 110 also include step 112 of calculating an area of discontinuity based on previously collected topologies of solidified layers of powdered material 18 and solidified layers of workpiece 20.

Step 114 includes identifying any areas of discontinuity in the first topology dataset. Step 114 also includes step 116 of predicting areas of concern of the layers of powdered material 18 based on an analysis of a nominal model of powder bed 14 and workpiece 20. Step 118 includes creating a first output dataset based on the identified areas of discontinuity in the first topology dataset. Step 120 includes sending the first output dataset to a second portion of controller 32. Step 122 includes converting the first output dataset to a first set of instructions for recoater 22 of the additive manufacturing system. Step 124 includes depositing a second layer of powdered material 18 on top of the first layer of workpiece 20 and on top of the first layer of powdered material 18. Step 126 includes sliding recoater 22 across the second layer of powdered material 18.

Step 128 includes varying heights of individual pins of the pin array based on the first set of instructions from controller 32 as recoater 22 is slid across the second layer of powdered material 18. Step 128 also includes steps 130, 132, and 134. Step 130 includes moving one of pins 36 of pin array 30 in a linear motion relative to shield 24 and relative to other pins 36 of pin array 36. Step 132 includes moving individual pins 36 with actuator 26. Step 134 includes adjusting pin array 30 to avoid recoater 22 from coming into contact with an elevated solid region of the first layer of workpiece 20. Step 136 includes adjusting a topology of the second layer of powdered material 18 with pins 36 of pin array 30 as recoater 22 is slid across the second layer of powdered material 18. In another example, during solidification, the parameters related to melting can be adjusted based on the varying thickness of the deposited powdered material 18.

Method 100 allows pin array 30 to avoid coming into contact with higher than usual solidified portions of workpiece 20 so as to prevent damage to recoater 22. In addition to avoiding higher than usual solid portions of powdered material 18, method 100 can be used to vary the thickness of powdered material 18 across build plate 16 allowing multiple layer thicknesses in varying areas of the build to create specific surface finishes, material properties, or increase build speed in areas of reduced concern.

Discussion of Possible Embodiments

A method of controlling powder in an additive manufacturing process includes solidifying a portion of a first layer of powder to form a first layer of a workpiece. A first topology indicative of the first layer of powder and the first layer of the workpiece is captured. The recoater is moved across the second layer of powder. Heights of portions of the recoater are varied while moving the recoater, based on the first topology captured, to avoid contact of the recoater with solidified portions of the first layer that could stress the portions of the recoater if the heights of the portions were not varied.

The method of the preceding paragraph can optionally include, additionally and/or alternatively, any one or more of the following steps, features, configurations and/or additional components.

The first topology can be sent to a first portion of a controller after the first topology is captured; and/or a first output dataset can be sent to a second portion of the controller after the first output dataset is created.

A topology of the second layer of powder can be adjusted with the pins of the pin array as the recoater is moved across the second layer of powder.

The recoater can comprise: a front shield; an array of pins that can be slideably mounted to the front shield; and an actuator that can be mounted to the front shield and/or operably connected to the array of pins; and/or a pin of the array of pins can be moved in a linear motion relative to the front shield and/or relative to the other pins of the pin array.

Individual pins can be moved with the actuator.

An area of discontinuity can be calculated based on previously collected topologies of solidified layers of powder and/or solidified layers of the workpiece.

Areas of concern of the powder layer can be predicted based on an analysis of a nominal model of the powder bed and the workpiece.

The first layer of powder and/or the first layer of the workpiece can be scanned with a structured light or a laser scanner.

The recoater can be adjusted to avoid the recoater from coming into contact with an elevated solid region of the first layer of the workpiece.

An additive manufacturing system includes a powder bed with a build plate, a recoater, a plurality of pins supported by the recoater, and a sensor. The recoater positioned above the powder bed and disposed to wipe across a top of the powder bed. The plurality of pins are configured to be individually moved relative to the recoater while the recoater is being wiped across the top of the powder bed. The sensor is configured to capture a topology of the powder bed for use in moving the plurality of pins relative to the recoater.

The system of the preceding paragraph can optionally include, additionally and/or alternatively, any one or more of the following features, configurations and/or additional components.

The recoater can comprise: a shield that can be disposed to move relative to the powder bed; an actuator that can be mounted to the shield; and/or a pin array that can comprise a plurality of pins, wherein each pin of the pin array can be connected to the actuator by a driving arm, wherein each pin of the pin array can be slideably engaged with the shield; and/or a controller can be electrically connected to the sensor and/or to the actuator, wherein the controller can be configured to send and/or receive electrical signals to and/or from the sensor and the actuator.

The controller can control actuation of each pin of the pin array via corresponding driving arm based on the captured topology of the powder bed.

A covering can be attached to a bottom face or to a leading edge of one of the pins of the pin array.

A covering can be attached to a bottom face or to a leading edge of the pin array.

The driving arm can comprise a plurality of driving arms extending between the actuator and the pins of the pin array, wherein one of the driving arms of the plurality of driving arms can be connected to the actuator and to one of the pins, wherein the actuator can be disposed to drive motion of the driving arms.

Each pin of the pin array can be slideably engaged with an adjacent pin of the pin array.

A method of controlling a height of deposited powder includes depositing a first layer of powder onto a powder bed. A portion of the first layer of powder is solidified to form a first layer of a workpiece. A first topology dataset is captured. Any areas of discontinuity are identified. A first output dataset based is created on the identified areas of discontinuity. The first output dataset is converted to a first set of instructions for a recoater of the additive manufacturing system. A second layer of powder is deposited on the first layer of the workpiece and on top of the first layer of powder. The recoater is slid across the second layer of powder. The heights of individual pins of the pin array are varied based on the first set of instructions from the controller as the recoater is slid across the second layer of powder.

The method of the preceding paragraph can optionally include, additionally and/or alternatively, any one or more of the following steps, features, configurations and/or additional components.

The first topology dataset can be sent to a first portion of a controller after the first topology dataset is captured; and/or the the first output dataset can be sent to a second portion of the controller after the first output dataset is created.

An area of discontinuity can be calculated based on previously collected topologies of solidified layers of powder and solidified layers of the workpiece; and/or areas of concern of the powder layer can be predicted based on an analysis of a nominal model of the powder bed and the workpiece.

The pin array can be adjusted to avoid the recoater from coming into contact with an elevated solid region of the first layer of the workpiece.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of controlling powder in an additive manufacturing process, the method comprising:
solidifying a portion of a first layer of powder to form a first layer of a workpiece;
capturing a first topology indicative of the first layer of powder and the first layer of the workpiece;
moving the recoater across the second layer of powder; and
varying heights of portions of the recoater while moving the recoater, based on the first topology captured, to avoid contact of the recoater with solidified portions of the first layer that could stress the portions of the recoater if the heights of the portions were not varied.

2. The method of claim 1, further comprising:
sending the first topology to a first portion of a controller after the first topology is captured; and
sending a first output dataset to a second portion of the controller after the first output dataset is created.

3. The method of claim 1, further comprising adjusting a topology of the second layer of powder with the pins of the pin array as the recoater is moved across the second layer of powder.

4. The method of claim 1, further comprising:
wherein the recoater comprises:
a front shield;
an array of pins slideably mounted to the front shield; and
an actuator mounted to the front shield and operably connected to the array of pins;
moving a pin of the array of pins in a linear motion relative to the front shield and relative to the other pins of the pin array.

5. The method of claim 1, wherein varying heights of portions of the recoater comprises moving individual pins with the actuator.

6. The method of claim 1, further comprising calculating an area of discontinuity based on previously collected topologies of solidified layers of powder and solidified layers of the workpiece.

7. The method of claim 6, further comprising predicting areas of concern of the powder layer based on an analysis of a nominal model of the powder bed and the workpiece.

8. The method of claim 1, wherein capturing the first topology of the first layer of powder and the first layer of the workpiece further comprises scanning the first layer of powder and the first layer of the workpiece with a structured light or a laser scanner.

9. The method of claim 1, further comprising adjusting the recoater to avoid the recoater from coming into contact with an elevated solid region of the first layer of the workpiece.

10. An additive manufacturing system comprising:
a powder bed with a build plate;
a recoater positioned above the powder bed and disposed to wipe across a top of the powder bed,
a plurality of pins supported by the recoater configured to be individually moved relative to the recoater while the recoater is being wiped across the top of the powder bed; and
a sensor configured to capture a topology of the powder bed for use in moving the plurality of pins relative to the recoater.

11. The additive manufacturing system of claim 10, further comprising:
wherein the recoater comprises:
a shield disposed to move relative to the powder bed;
an actuator mounted to the shield; and
a pin array comprising a plurality of pins, wherein each pin of the pin array is connected to the actuator by a driving arm, wherein each pin of the pin array is slideably engaged with the shield; and
a controller electrically connected to the sensor and the actuator, wherein the controller is configured to send and receive electrical signals to and from the sensor and the actuator.

12. The additive manufacturing system of claim 11, wherein the controller controls actuation of each pin of the pin array via corresponding driving arm based on the captured topology of the powder bed.

13. The additive manufacturing system of claim 11, further comprising a covering that is attached to a bottom face or to a leading edge of one of the pins of the pin array.

14. The additive manufacturing system of claim 11, further comprising a covering that is attached to a bottom face or to a leading edge of the pin array.

15. The additive manufacturing system of claim 11, wherein the driving arm comprises a plurality of driving arms extending between the actuator and the pins of the pin array, wherein one of the driving arms of the plurality of driving arms is connected to the actuator and to one of the pins, wherein the actuator is disposed to drive motion of the driving arms.

16. The additive manufacturing system of claim 11, wherein each pin of the pin array is slideably engaged with an adjacent pin of the pin array.

17. A method of controlling a height of deposited powder in an additive manufacturing process, the method comprising:
depositing a first layer of powder onto a powder bed of an additive manufacturing system;
solidifying a portion of the first layer of powder to form a first layer of a workpiece;
capturing a first topology dataset of the first layer of powder and the first layer of the workpiece;
identifying any areas of discontinuity in the first topology dataset;
creating a first output dataset based on the identified areas of discontinuity in the first topology dataset;
converting the first output dataset to a first set of instructions for a recoater of the additive manufacturing system, wherein the recoater comprises:
a front shield;
an array of pins slideably mounted to the front shield; and
an actuator mounted to the front shield and operably connected to the array of pins;
depositing a second layer of powder on top of the first layer of the workpiece and on top of the first layer of powder; and
sliding the recoater across the second layer of powder while varying heights of individual pins of the pin array based on the first set of instructions from the controller.

18. The method of claim 17, further comprising:
sending the first topology dataset to a first portion of a controller after the first topology dataset is captured; and
sending the first output dataset to a second portion of the controller after the first output dataset is created.

19. The method of claim 17, further comprising:
calculating an area of discontinuity based on previously collected topologies of solidified layers of powder and solidified layers of the workpiece; and
predicting areas of concern of the powder layer based on an analysis of a nominal model of the powder bed and the workpiece.

20. The method of claim 17, further comprising adjusting the pin array to avoid the recoater from coming into contact with an elevated solid region of the first layer of the workpiece.
